(19) United States
(12) Patent Application Publication
(10) Pub. No.: US 2008/0153064 A1
(43) Pub. Date: Jun. 26, 2008

(54) Waved Implant Integrating Soft Tissue Area and Osseous Tissue Area

(76) Inventors: Chong Hyun Han, Seocho-gu (KR); Sin Koo Kim, Seoul (KR)

Correspondence Address: KLARQUIST SPARKMAN, LLP, 121 SW SALMON STREET, SUITE 1600, PORTLAND, OR, 97204, US

(21) Appl. No.: 11/909,702

(22) PCT Filed: Mar. 28, 2006
(86) PCT No.: PCT/KR2006/001131

§ 371 Date: Sep. 25, 2007

(30) Foreign Application Priority Data
Mar. 28, 2005 (KR) 10-2005-0025585

(51) Int. Cl. A61C 8/00

(52) U.S. Cl. 433/174

(57) ABSTRACT

Disclosed relates to a waved implant integrating a soft tissue area and an osseous tissue area and, more particularly, to a soft tissue area and an osseous tissue area that prevents fine motion of an artificial tooth, intercepts the infiltration of bacteria in the vicinity of the implant and preserves the gingival shape of the natural tooth. Accordingly, it is possible to prevent fine motion of the artificial tooth, intercept the infiltration of bacteria in the vicinity of the implant and preserves the gingival shape of the natural tooth.

### TECHNICAL FIELD

The present invention relates to a waved implant integrating soft tissue area and osseous tissue area and, more particularly, to a waved implant integrating soft tissue area and osseous tissue area that prevents fine motion of an artificial tooth, keeps the implanted vicinities from being infected and preserves the gingival shape of the natural teeth.

### BACKGROUND ART

Generally, one of the peculiar functions of teeth is to grind food to digest well. If losing teeth, people cannot chew food to digest well. Accordingly, people cannot eat his or her fill to take in sufficient nutrition for good health.

If losing a permanent tooth after exchanged from a milk tooth in childhood, a further tooth will not be cut. Accordingly, it is necessary to restore the masticatory function by rehabilitate the lost tooth and its surroundings via a prosthetic treatment in dental service.

However, general dental treatments may be accompanied with somewhat of damages to neighboring teeth, gums and osseous tissues. Even in case of using dentures, it carries drawbacks that it causes the decrease of masticatory function, inconvenience for the foreign body and the like, compared with the natural teeth.

One of the solutions proposed against the drawbacks of the general prosthetic treatment is artificial tooth transplantation. According to the artificial tooth transplantation, it is possible to restore all functions and appearances fairly identical with the natural tooth.

As described above, the artificial tooth in the limelight recently functions as an artificial substitute for the natural tooth.

As depicted in FIGS. 1 and 2, the artificial tooth comprises a fixture (artificial tooth root) 103, an abutment 105 and a process tooth 107. The fixture 103 for supporting the process tooth 107 is anchored to an alveolar bone 109 in the vicinity of the lost tooth, like a tooth root in a natural tooth. The abutment 105 put in the gum is to couple the fixture 103 and the process tooth 107. The process tooth 107 fixed on the abutment 105 in the mouth is designed to provide the same shapes and functions as the natural tooth.

Hereinafter, the process of transplanting an artificial tooth 101 in the region of the lost tooth will now be discussed.

The process of transplantation is roughly divided into a surgical operation and a prosthetic rehabilitation.

Biocompatibility is checked including a blood test, etc., prior to the operation. The region of transplantation is selected for operation. An oral inspection, radiographic test, etc., are carried out in advance for evaluating the quality and quantity of osseous tissues in the region of transplantation.

When completing a series of tests, the surgical operation is begun.

First, a primary operation is executed to transplant the fixture 103 corresponding to the tooth root in the natural tooth in the alveolar bone 109 under a local anesthesia. Here, a gum 111 is excised to expose the alveolar bone 109. Then, the fixture 103 is inserted into the alveolar bone 109 and the gum 111 is sutured.

After a lapse of 3 to 6 months based on the osseous tissues, a secondary operation is carried out.

The gum 111 sutured is excised again to put the abutment 105 on the top of the fixture 103. A connection screw 115 is inserted through an insertion hole 113 formed in the center of the abutment 105. The connection screw 115 is engaged with an engagement hole 117 formed in the center of the fixture 103, coaxial with the insertion hole 113, to fix the abutment 105 on the top of the fixture 103 in the gums 111. Like this, extruding the abutment 105 via the gums 111 in the mouth completes the secondary operation.

Subsequently, the prosthetic treatment is followed.

First, a gold cylinder 121 is put on the top of the abutment 105 coaxially. Here, an upper extrusion 119 of the connection screw 115 is inserted into a lower penetration hole 123 having a shape of a truncated cone in the gold cylinder 121. Then, the process tooth 107 is processed on the top of the gold cylinder 121 in a general manner. A gold screw 129 is inserted through a tooth hole 127 penetrated along with the centerline of the process tooth 107. By engaging the gold screw 129 with an engagement hole 125 penetrated on the top of the extrusion 119 of the connection screw 115, the transplantation of the artificial tooth 101 is completed.

However, when applying the artificial tooth 101 to a front tooth, as depicted in FIG. 3, the portion B other than the alveolar bone A, excised to anchor the implant 03 to the alveolar bone A, has not a supporter for adhering to, differently from the vicinity C of the fixture 103. Accordingly, the alveolar bone B may be resorbed as time goes by and the gums 111 may be involuted.

The involution of the gums 111 has the following problems:

First, it widens the space between the artificial tooth and the gums or the space between the artificial tooth and the alveolar bone, which shortens the durability of the artificial tooth; and second, it widens the space between the artificial tooth and the gums or the space between the artificial tooth and the alveolar bone, which makes bacteria to infiltrate the space, thus causing mouth odors and oral diseases.

### DISCLOSURE

### Technical Problem

Accordingly, an object of the present invention is to provide a waved implant integrating a soft tissue area and an osseous tissue area that prolongs the durability of the artificial tooth and prevents the deformation of the gums, mouth odors and oral diseases by reducing the space between the artificial tooth and the alveolar bone to prevent the resorption of the alveolar bone and the involution of the gums.

### Technical Solution

To accomplish the above technical object, the present invention provides a waved implant integrating a soft tissue area and an osseous tissue area comprising: a screw portion inserted into an alveolar bone; a flange, connected with an upper end of the screw portion and inserted into the alveolar bone, in which an upper end is formed having a waved shape that the front and the rear are concave and the right and the left are convex, including a plurality of microthreads having a thread pitch and/or a thread depth smaller and denser than those of the screw portion; and a soft tissue area combined with the top of the flange in a body.

The threaded portion of the screw according to the present invention may be formed in, but not limited to, triangular threads (hereinafter, triangular screw) or rectangular threads (hereinafter, rectangular screw).

The surface of the microthreads is treated in the unit of μm, preferably, to have an average surface roughness of about 1 to 2 μm.

The surface treatment may be made via a blasting, an etching or an anodizing method, which is, however, not limited.

The waved shape of the upper end of the flange may be formed dually along with the circumferential surface in which the microthreads are arranged.

The shape of the top of the soft tissue area may be formed identical with that of the flange.

The shape of the top of the soft tissue area may be a polygon having ears.

The shape of the top of the soft tissue area may be even.

The shape of the soft tissue area may be a waveform.

Furthermore, the portion between the soft tissue area and the flange may have a slender shape, referred to as Monroe's waist, which is curved sharply from the flange in an upper and inner direction and extended to the soft tissue area. Here, a cosine angle θ between the flange and the soft tissue area is about 10° to 90°.

The soft tissue area has the same composition as the osseous tissue area.

### Advantageous Effects

As can be seen from the foregoing, since the waved implant integrating the soft tissue area and the osseous tissue area in accordance with the present invention is installed in a bio or artificial soft tissue in a body during the operation, it prevents the resorption of the alveolar bone 9 and the involution of the gums 11 that may be caused by excising and suturing the neighboring gums, thus intercepting the infiltration of bacteria. Furthermore, it is possible to use the implant installed for a longer time, which saves time and money, and to increase an aesthetic appreciation by restoring the gums of natural teeth.

### DESCRIPTION OF DRAWINGS

The above and other features of the present invention will be described with reference to certain exemplary embodiments thereof illustrated the attached drawings in which:

FIG. 1 is a perspective view illustrating a structure of a conventional and general artificial tooth and a state lo of the artificial tooth installed;

FIG. 2 is an exploded perspective view of FIG. 1;

FIG. 3 is a front view showing how the conventional artificial tooth is transplanted in the region of a front tooth;

FIG. 4 is a front view depicting how a waved implant integrating a soft tissue area and an osseous tissue area in accordance with an embodiment of the present invention is transplanted in the region of a front tooth;

FIG. 5 is a side view of FIG. 4;

FIGS. 6 to 8 are side view each depicting how a waved implant integrating a soft tissue area and an osseous tissue area in accordance with another embodiment of the present invention is transplanted in the region of a front tooth;

FIGS. 9 to 11 are side view of FIGS. 6 to 8;

FIG. 12 is a side view showing how a waved implant integrating a soft tissue area and an osseous tissue area in accordance with still another embodiment of the present invention is transplanted in the region of a front tooth; and

FIG. 13 is a side view of FIG. 12.

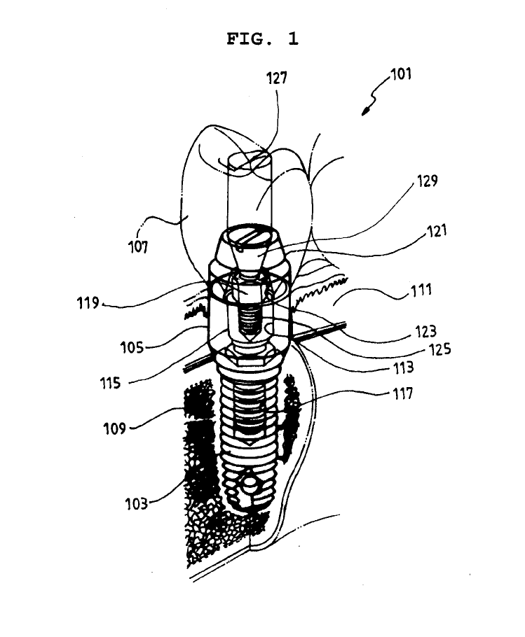

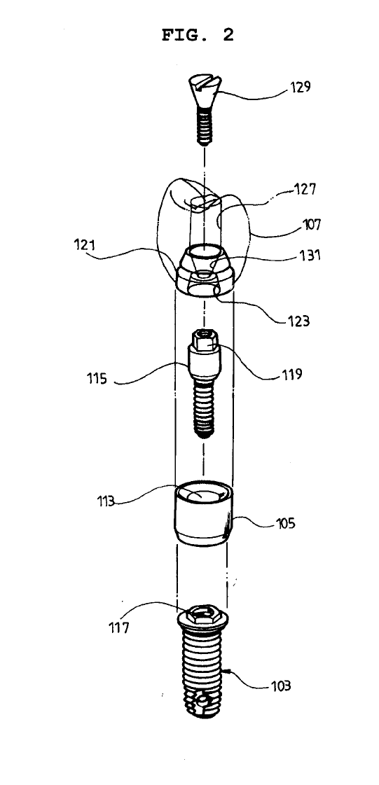

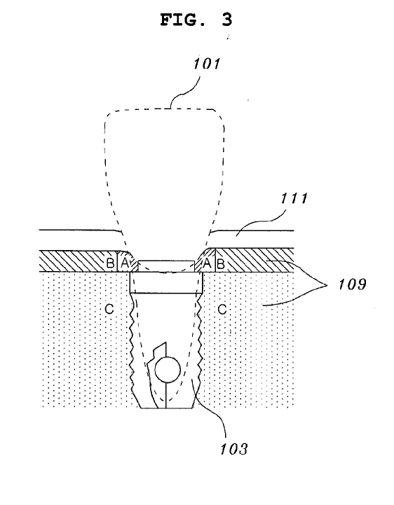

### DESCRIPTION OF MAJOR SYMBOLS IN THE ABOVE FIGURES

| | |
|---|---|
| 3: | Implant |
| 9: | Alveolar bone |
| 9′: | Cortical bone |
| 13: | Screw portion |
| 14: | Cutting edge |
| 15: | Flange |
| 15a: | Cortical bone contact portion |
| 15b: | Gum contact portion |
| 17: | Screwthread |
| 21: | Microthread |
| 22, 22a, 22b and 22c: | Soft tissue area |

### MODE FOR INVENTION

Hereinafter, a waved implant integrating a soft tissue area and an osseous tissue area in accordance with the present invention will now be described more fully with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art.

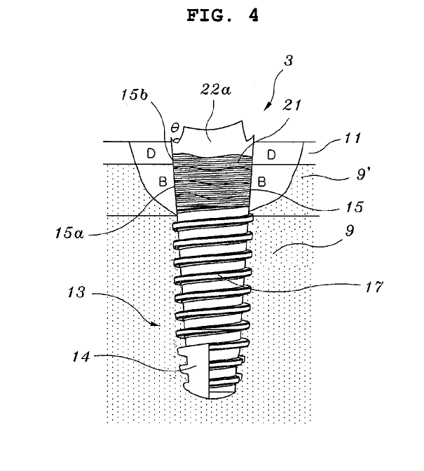

FIG. 4 is a front view depicting how a waved implant integrating a soft tissue area and an osseous tissue area in accordance with an embodiment of the present invention is transplanted in the region of a front tooth. As depicted in the figure, an implant 3 comprises a screw portion 13, a flange 15 connected with the top of the screw portion 13 and a soft tissue area 22a combined with the top of the flange 15 integratedly.

The implant is installed in an alveolar bone 9 by means of the screw portion 13. The screw portion 13 includes a screwthread 17 and a cutting edge 14.

A triangular screw is generally used, however, a rectangular screw may be used to increase the coherence, which is, however not limited. In a preferred embodiment of the invention, the upper part of the screw portion 13 has an outer diameter of about 3.0 to 5.0 mm and the lower part of the screw portion 13 has an outer diameter of about 1.0 to 3.0 mm, thus having a shape that a rectilinear body becomes smaller sharply in the region of the lower part. The screwthread 17 of the screw portion 13 having a thread depth of about 400 μm, a thread pitch of about 800 μm and an inclined structure at an upward angle of 0° to 10° is formed on the circumferential surface. Accordingly, the implant 3 can be installed in the bone tissue via the rotation of the screw portion 13.

The cutting edge 14 is formed by cutting off both ends of the lower part of the screw portion 13 at an angle of about 90 degrees to enhance the installation stability of the implant 3. The cutting edge 14 may increase the bone mineral density in the vicinity of the screw portion 13 since it compresses the vicinity of the screw portion 13 according to the insertion of the implant. At the same time, it is possible to reduce the time required for the bone tissue to adhere to the implant.

In this embodiment, the flange 15 is inserted into the cortical bone 9′ on the alveolar bone 9. The upper end of the flange 15 is formed curved with a polygonal shape, such as trigonal or tetragonal shape, having ears for preventing the involution of the gums. Besides, the upper end of the flange 15 may be formed variously having a wave or sinusoidal wave, a chopping wave or triangular wave, etc. Accordingly, the upper end of the flange 15 may perform a role that prevents the flange 15 of the implant 3 from being resorbed into the alveolar bone, which may happen after the insertion of the implant. For example, in case that the upper end of the flange 15 is formed with a shape of a waved edge (Taeguk edge), the shape may have a waveform that the front and the rear are concave and the right and the left are convex or a waveform that the front and the rear are convex and the front and the rear are concave.

Microthreads 21 are densely formed on the body of the flange 15. The microthreads 21 strengthen the coherence with the cortical bone 9′ and, at the same time, diversify the stress generated during the use of the implant 3. For lo this purpose, the microthreads or fine threads 21 having a thread depth and/or a thread pitch smaller than those of the screwthreads 17 of the screw portion 13 are formed densely. For example, the microthreads 21 has a thread depth of about 1 to 25 μm, a thread pitch of about 200 to 400 μm and an upward angle of 0° to 5° is formed on the circumferential surface of the flange 15. Here, the microthreads 21 may be formed, having a rectilinear shape inclined at an upward angle of 0° to 5°, or having the wave edge, the sinusoidal wave, or the chopping wave, the triangular wave like the upper end of the flange 15 over the circumferential surface of the flange.

In particular, it is desirable that the surface of the microthreads 21 is processed roughly to prevent the involution of the gums. The surface treatment of the microthreads 21 may be processed via blasting, etching, anodizing and the like, which is, however, not limited. Examples will be described in detail hereinafter.

Sand blasting method is directed to a surface treatment that reforms the surface of the microthreads 21 roughly by injecting sands or fine sands, such as silica, under high pressure.

Grit blasting method is a surface treatment method that increases the blasting effect on the surface of the microthreads 21 using grits having a sharp edge made by lo crushing nodular cast irons instead of sands or fine sands.

Etching method is to corrode the surface of the microthreads 21 using chemicals to be roughly uneven.

The surface of the microthreads 21 may be processed selecting one of the above methods to have an average surface roughness in the unit of μm, preferably, of about 1 to 2 μm.

Meanwhile, anodizing method is directed to a surface treatment that anodizes surfaces of aluminum alloy, magnesium alloy, titanium alloy, etc. For example, a metal to be processed is coupled to an anode and an inert metal is connected with a cathode in electrolyte. Then, an electric current is applied to the electrodes to form oxidized films on the surfaces of aluminum, magnesium, titanium, etc. Accordingly, it is possible to increase the corrosion resistance by preventing further oxidizations into the inside of the metal.

In particular, the flange 15 is divided into a contact portion 15a contacting with the cortical bone 9′ on the alveolar bone 9 and a contact portion 15b contacting with the gums 11. An end portion B of the cortical bone 9′ may adhere well to the contact portion 15a contacting with the cortical bone 9′ by means of the microthreads 21 and their rough surface. Besides, the flange 15 may be combined well with the process tooth by means of the microthreads 21 having the waved edge.

In this embodiment, the soft tissue area 22a may be formed of a polygonal shape such as trigonal, tetragonal, pentagonal, or hexagonal shape, having ears connected with the flange in a body. The ears of the soft tissue area 22a are extended to the top of the gums 11. Accordingly, the end portion B of the cortical bone 9′ that is a portion remaining after excision, is not resorbed. Besides, a top end portion D of the gums 11 does not involute. Furthermore, since the gums do not involute, it is possible to prevent bacteria from infiltrating between the artificial tooth and the gums 11 or between the artificial tooth and the alveolar bone 9, and to keep the form of the gums of the natural tooth.

Here, the top end portion D of the gums 11 may contact with the contact portion 15b contacting with the gums 11 and with the soft tissue area 22a at the same time.

Moreover, since the soft tissue 22a is extended to the top of the gums 11 in a body, the installation operation of a process tooth, not depicted, may be readily performed. That is, since the process tooth is installed on the soft tissue area 22a, the artificial tooth can be seated without fine motion and prevent the gums from involuting additionally to keep the shape of the gums 11 of the natural teeth, thus increasing an aesthetic appreciation.

The cosine angle θ between the soft tissue area 22a and the flange 15 may be adjusted 10° to 90° based on the shapes of the process tooth and the soft tissue area 22a. Forming the cosine angle as such can maintain an effective closing in the region of combination between the soft tissue area 22a and the flange 15. Accordingly, it is possible to enhance the stability of soft tissue and, at the same time, to prolong the durability or lifetime of the artificial tooth.

Besides, the composition of the soft tissue area 22a is identical with that of the osseous tissue area; however, the surface of the soft tissue area 22a may be an even state that the surface treatment is not made, after a turning. Here, the composition of the soft tissue area 22a includes hydroxyapatite, etc., which is, however, not limited.

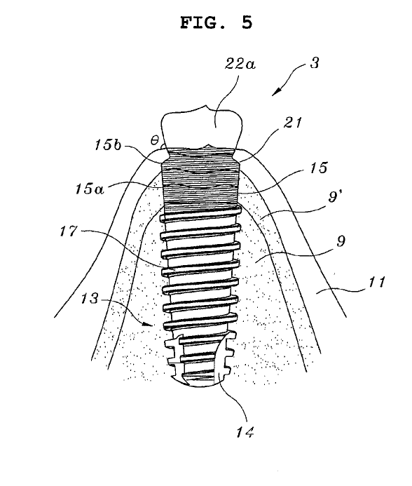

FIG. 5 is a side view of FIG. 4. As depicted in the figure, the upper end of the flange 15 is formed of a polygonal shape having a vertex and the soft tissue area 22a has the same shape as the flange 15, thus preventing the fine motion of the implant 3.

Since the soft tissue area 22a is formed with the implant in a body 3 and the flange 15 having the waved shape is extended to the gums 11, it is possible to prevent the resorption of the cortical bone 9′ and the involution of the gums 11 due to the excision, thus intercepting the infiltration of bacteria.

Furthermore, the portion between the soft tissue area 22a and the flange 15 may have a slender shape, referred to as Monroe's waist, which is curved sharply from the flange 15 in an upper and inner direction and extended to the soft tissue area 22a. Thereby, it is possible to increasingly prevent the involution of the gums 11.

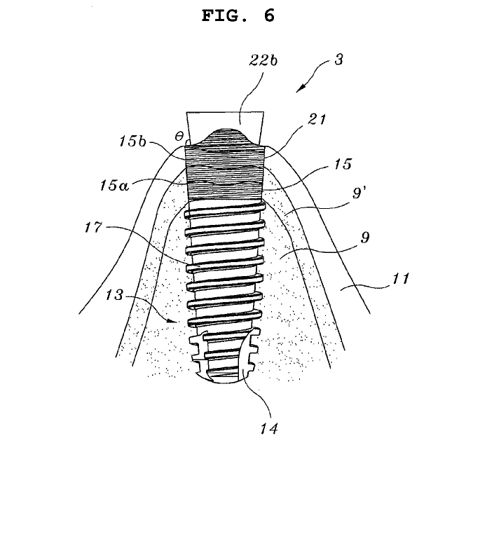

Meanwhile, FIG. 6 is a side view depicting how a waved implant integrating a soft tissue area and an osseous tissue area in accordance with another embodiment of the present invention is transplanted in the region of a front tooth. As depicted in the figure, the upper end of the flange 15 has a hemispheric shape and the lower end has a waved shape, thus preventing the fine motion of the implant 3. The upper end of the soft tissue area 22b is formed even. Since the soft tissue area 22b is formed with the implant 3 in a body and the flange 15 having a hemispheric shape in the middle is extended to the gums 11, it is possible to prevent the resorption of the cortical bone 9′ and the involution of the gums 11 due to the excision, thus intercepting the infiltration of bacteria.

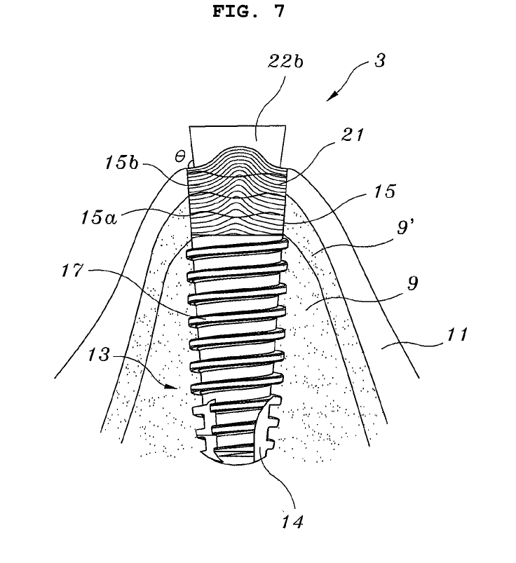

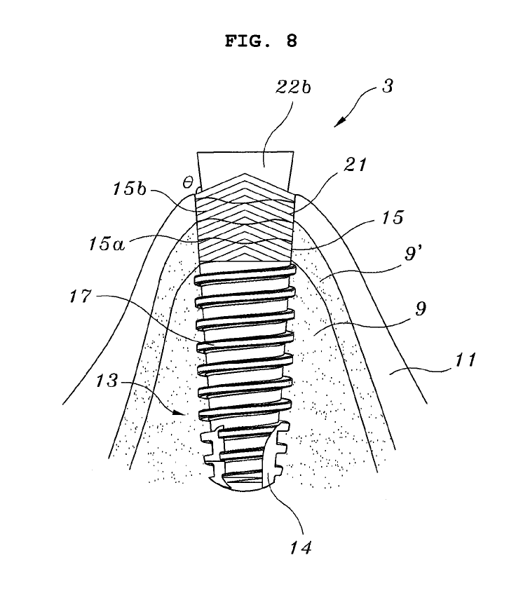

FIG. 6 shows the microthreads 21 of the flange 15 formed rectilinearly; FIG. 7 depicts the microthreads 21 of the flange 15 formed in a waved shape or sinusoidal shape; and FIG. 8 illustrates the microthreads 21 of the flange 15 formed in a chopping wave or triangular wave.

The other conditions of the embodiment are identical with those described with reference to FIGS. 4 and 5.

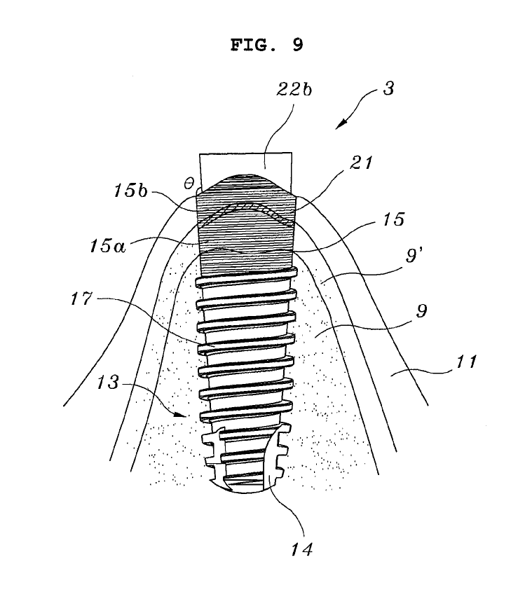

FIG. 9 is a side view of another embodiment of FIG. 6, wherein a dual wave is formed on the circumferential surface of the flange 15. As shown in the figure, the upper end of the flange 15 having the dual wave is formed hemispheric and the lower end of the flange 15 is formed in a dual waved shape, thus preventing the fine motion of the implant 3 more and more. Since the soft tissue area 22b is formed with the implant 3 in a body and the flange 15 having a hemispheric shape in the middle is extended to the gums 11, it is possible to prevent the resorption of the cortical bone 9′ and the involution of the gums 11 due to the excision, thus intercepting the infiltration of bacteria. The upper end of the soft tissue area 22b has a leveling shape.

That is, since the flange 15 has the dual waved shape, it provides resistances for fine motion of the implant 3, resorption of the cortical bone 9′ and the involution of the gums 11 larger than the flange 15 having a single waved shape.

The boundary of the waved shape may be that between the cortical bone contact portion 15a and the gum contact portion 15b or may be an upper or lower portion.

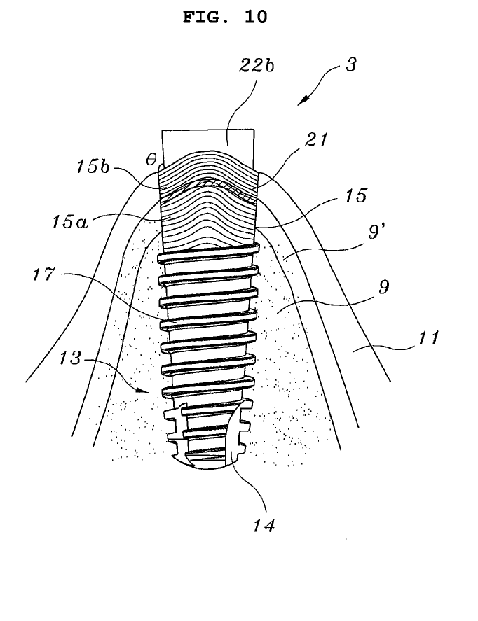

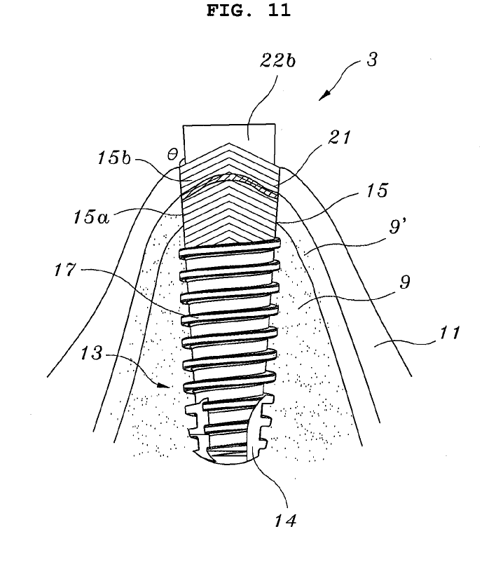

FIG. 9 shows the microthreads 21 of the flange 15 having the dual wave formed rectilinearly; FIG. 10 depicts the microthread 21 of the flange 15 having the dual wave formed in a waved shape or sinusoidal shape; and FIG. 11 illustrates the microthreads 21 of the flange 15 having the dual wave formed in a chopping wave or triangular wave.

The other conditions of the embodiment are identical with those described with reference to FIGS. 6 and 8.

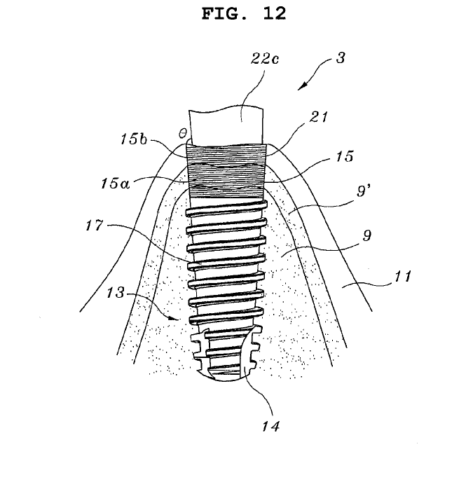

FIG. 12 is a side view showing how a waved implant integrating a soft tissue area and an osseous tissue area in accordance with still another embodiment of the present invention is transplanted in the region of a front tooth. As shown in the figure, since the flange 15 is formed in a waved shape and the soft tissue area 22c is formed in a waved shape as well, it is possible to prevent the fine motion of the implant 3 more and more. Furthermore, since the soft tissue area 22c is formed with the implant 3 in a body and the flange 15 having a waved shape is extended to the gums 11, it is possible to prevent the resorption of the cortical bone 9′ and the involution of the gums 11 due to the excision, thus intercepting the infiltration of bacteria.

The other conditions of the embodiment are identical with those described with reference to FIGS. 4 and 5.

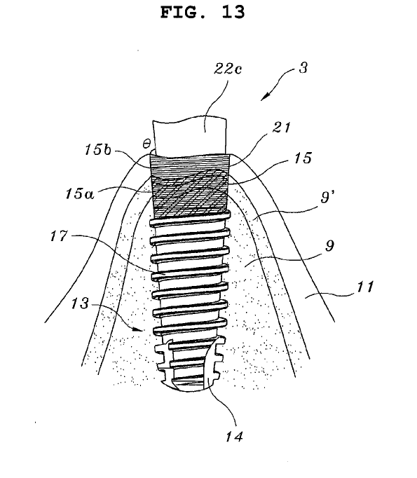

FIG. 13 is a side view of another embodiment of FIG. 12, wherein a dual wave is formed on the circumferential surface of the flange 15. As shown in the figure, since the flange 15 is formed in a waved shape and the soft tissue area 22c is formed in a waved shape as well, it is possible to prevent the fine motion of the implant 3 more and more. Furthermore, since the soft tissue area 22c is formed with the implant 3 in a body and the flange 15 having a waved shape is extended to the gums 11, it is possible to prevent the resorption of the cortical bone 9′ and the involution of the gums 11 due to the excision, thus intercepting the infiltration of bacteria.

That is, since the flange 15 has the dual waved shape, it provides resistances for fine motion of the implant 3, resorption of the cortical bone 9′ and the involution of the gums 11 larger than the flange 15 having a single waved shape.

The boundary of the waved shape may be that between the cortical bone contact portion 15a and the gum contact portion 15b or may be an upper or lower portion.

The other conditions of the embodiment are identical with those described with reference to FIGS. 9 and 11.

Although the present invention has been described with reference to certain exemplary embodiments thereof, it will be understood by those skilled in the art that a variety of modifications may be made therein without departing from the spirit or scope of the present invention defined by the appended claims and their equivalents.

1. A waved implant integrating a soft tissue area and an osseous tissue area comprising:
a screw portion inserted into an alveolar bone;
a flange, connected with an upper end of the screw portion and inserted into the alveolar bone, in which an upper end is formed having a waved shape that the front and the rear are concave and the right and the left are convex, including a plurality of microthreads having a thread pitch and/or a thread depth smaller and denser than those of the screw portion; and
a soft tissue area combined with the top of the flange in a body.

2. The waved implant integrating a soft tissue area and an osseous tissue area as recited in claim 1,
wherein the screw portion has a triangular screw or a rectangular screw.

3. The waved implant integrating a soft tissue area and an osseous tissue area as recited in claim 1,
wherein the microthreads of the flange are formed having a structure of a waved shape or a chopping wave shape.

4. The waved implant integrating a soft tissue area and an osseous tissue area as recited in claim 1,
wherein the microthreads of the flange are formed on a circumferential surface of the flange and have a thread depth of about 1 to 25 μm, a thread pitch of about 200 to 400 μm and an inclined structure at an upward angle of 0° to 5°.

5. The waved implant integrating a soft tissue area and an osseous tissue area as recited in claim 1,
wherein the surface of the microthreads is treated to have an average surface roughness of 1 to 2 μm.

6. The waved implant integrating a soft tissue area and an osseous tissue area as recited in claim 5,
wherein the surface treatment is made via a blasting, an etching or an anodizing method.

7. The waved implant integrating a soft tissue area and an osseous tissue area as recited in claim 1,
wherein the waved shape of the flange is formed dually.

8. The waved implant integrating a soft tissue area and an osseous tissue area as recited in claim 1,
wherein the shape of the soft tissue area is formed identical with that of the flange.

9. The waved implant integrating a soft tissue area and an osseous tissue area as recited in claim 1,
wherein the shape of the soft tissue area is a polygon having ears.

10. The waved implant integrating a soft tissue area and an osseous tissue area as recited in claim 1,
wherein the shape of the top of the soft tissue area is even.

11. The waved implant integrating a soft tissue area and an osseous tissue area as recited in claim 1,
wherein the shape of the soft tissue area is a waveform.

12. The waved implant integrating a soft tissue area and an osseous tissue area as recited in claim 1,
wherein a portion between the soft tissue area and the flange is formed having a slender shape, which is curved sharply from the flange in an upper and inner direction and extended to the soft tissue area.

13. The waved implant integrating a soft tissue area and an osseous tissue area as recited in claim 1,
wherein a cosine angle θ between the flange and the soft tissue area is 10° to 90°.

14. The waved implant integrating a soft tissue area and an osseous tissue area as recited in claim 1,
wherein the soft tissue area has the same composition as the osseous tissue area.
